(19) United States
(12) Patent Application Publication
(10) Pub. No.: US 2020/0236982 A1
(43) Pub. Date: Jul. 30, 2020

(54) TREE NUT POWDER FORMULATION

(71) Applicant: LIL MIXINS, LLC, PHILADELPHIA, PA (US)

(72) Inventor: MEENAL LELE, Philadelphia, PA (US)

(21) Appl. No.: 16/686,380

(22) Filed: Nov. 18, 2019

Related U.S. Application Data
(60) Provisional application No. 62/797,673, filed on Jan. 28, 2019.

(51) Int. Cl. A23L 25/00; A23L 33/00; A23L 5/10; A23C 9/20

(52) U.S. Cl. CPC A23L 25/30; A23L 33/40; A23V 2002/00; A23C 9/206; A23L 5/15

(57) ABSTRACT

A nut food product is provided that when mixed with baby food and given regularly to a baby will reduce the likelihood of the baby developing a food allergy to nuts. The nut food product is produced by taking various nuts and shelling them. The shelled nuts are then crushed in order to form a paste after which the nuts are defatted. Once defatted, the nuts are ground down in size and then blended together in order to form a powder.

This application claims priority from U.S. Provisional Application No. 62/797,673 filed Jan. 28, 2019.

### BACKGROUND OF THE INVENTION

As is well known, food allergy rates have been on the rise throughout the United States as well as worldwide.

In 2015, the LEAP study was published showing that in high risk children, (even if skin testing indicated that they were already sensitized), you could reduce the rate of the peanut allergy by 80% by feeding infants peanut protein regularly. These results were so striking that in the same year, the American Academy of Pediatrics, the governing body of pediatricians, began recommending that all babies be fed peanuts regularly, starting at the early age of between 4 and 6 months old.

Subsequently, several studies and subsequent meta-analysis have shown that regular exposure in infants of common food allergens beginning between ages 4 and 6 months old can provide protection against food allergies. The problem, however, is that babies cannot eat unprepared food in their natural form at that young an age. They choke easily and typically require food in mush or slurry form.

Further, food products specifically created for consumption by babies in order to reduce the risk of developing a food allergy to one or more tree nuts should:

contain an adequate quantity of the food (per clinical studies)

retain fiber, flavor, and nutrients from the original food

not be treated in a way that denatures the proteins in the food

minimize the risk of choking

reduce the chance of bacterial/fungal growth

include as many nuts as feasible in order to inhibit sensitization to as many tree nuts as possible.

There is currently available in the marketplace a product that can be fed directly to a baby sold under the name SpoonfulOne. This product is a powder blend of small amounts of different food protein. These foods include peanuts, milk, eggs, almonds, soy, wheat, shrimp, cashews, hazelnuts, oat, cod, pecans, salmon, sesame, walnuts, and pistachios. Each daily serving pouch includes less than 1 gram total of 16 different proteins. SpoonfulOne is less than desirable since it does not include enough of each of the proteins.

There is also product sold under the name Inspired Start, which has a pouch of banana & tree nut containing 1 gram of each tree nut protein (almond, walnut, and cashew) for a total of 3 grams. Each pouch is produced by puree-ing the desired protein with a very sweet fruit in order to create natural sweetness. Inspired Start is less than desirable since it contains too much sugar.

Other alternatives include:

nut flours such as almond flour, walnut flour, etc. which can come in coarse or fine form. All such flours have fat in them so when mixed with water, the flour holds together, or they will not properly blend. All are designed as a replacement for wheat flour. However, nut flour is disadvantageous since it clumps, thereby creating a choking hazard. It also retains fat and can more easily go rancid.

nut butters such as almond butter, cashew butter, etc. All of these butters require heating and thinning with water or milk before giving to baby. Unfortunately, nut butters have negative attributes including clumping, which can lead to choking, as well as thinning and other preparation activities that are required before serving to a baby.

mixed nut butter, which are butters that have added salt and sugar and which also have to be thinned.

powdered almond butter, which is defatted almond butter. The disadvantage is that the product includes only a single nut.

Reference is also made to U.S. Pat. Nos. 3,901,983A, 5,164,217A, 2,003,415 and 3,294,549 which describe processes for the manufacture of defatted peanut, and U.S. Pat. No. 4,321,280A, which discloses a process for preparing textured oil seed protein products.

Accordingly, it would be desirable to provide a nut food product that is specially created for babies in order to ensure ease of use and infant safety. The product should contain a suitable quantity of food protein, and should not be overly processed so as to still retain the fiber and nutrients of the original food. Additionally, the nut food product should have a minimal risk of choking and should have a markedly reduced chance of bacterial or fungal growth.

### SUMMARY OF THE INVENTION

Generally speaking, in accordance with the invention, a nut food product is provided that when mixed with baby food and given regularly to a baby will reduce the likelihood of the baby developing a food allergy to nuts. The nut food product is produced by taking various nuts and shelling them. The shelled nuts are then crushed in order to form a paste after which the nuts are defatted. Once defatted, the nuts are ground down in size and then blended together.

The produced blend of nuts is then proportioned and mixed into breastmilk, formula or appropriately pureed foods for subsequent feeding to infants.

Accordingly, it is an object of the invention to provide an improved nut food product for infants or babies.

Another object of the invention is to provide a nut food product which has a sufficient amount of protein.

A further object of the invention is to provide a nut food product that is easy for an infant or baby to eat and digest.

Still other objects and advantages will be obvious from the following description.

### DETAILED DESCRIPTION OF THE INVENTION

The inventive process and product produced thereby begins by selecting various nuts, such as almonds, walnuts, pistachios and hazelnuts, and having the nuts shelled so they are free from shell and skin. The shelled nuts are then crushed in order to form a paste. This is achieved by splitting or crushing the shell, either by hand or using machinery.

The next step in the inventive process is to defat the nuts. The nuts are defatted by uniformly applying pressure to the nuts in an amount between about a pressure of 1000 to 6000 psig (pounds per square inch gauge) in a conventional hydraulic press or a cage and for a time frame of between about 5 to 20 minutes. During the application of pressure, water should not be introduced. Preferably, at least 50% of the fat should be removed from the raw nut. Even more preferably, 80% of the fat should be removed.

The inventive process may then include roasting or heating the nuts during the process in order to enhance flavor. This step is not required in accordance with the inventive process. If the nuts are heated, this should be for a time period of between about 5 and 10 minutes. In order to preserve stability, heating should be carried out at a temperature of less than 90 degrees C. Significantly, if heating of the nuts is carried out, it is important not to hydrate prior to heating as this has been shown to denature the protein in certain nuts.

After defatting the nuts, the nuts are ground down in size. This is achieved by milling the nuts such that each nut can pass through at least a 40 mesh screen, preferably through at least a 200 mesh screen.

The ground nuts are then blended together in order to produce a nut blend or powder, with preferably a substantially even amount of the nuts by weight (almonds, walnuts, pistachios and hazelnuts) being present in the resulting “tree nut blend”. No additives such as sugar, salt, desiccants or preservatives are added.

The nuts may also be blended together prior to milling.

Although the combination of almonds, walnuts, pistachios and hazelnuts is preferred in the tree nut blend, other nuts such as cashew and pine nuts may be included or substituted as part of the inventive mixture.

In use, the tree nut blend is proportioned and fed to infants older than 4 months old. This is done by mixing the blend into breastmilk, formula, or developmentally-appropriate pureed foods. Suitable pureed foods include vegetables, fruits, yogurt or wheat cereal. The tree nut blend is preferably fed to infants in serving sizes of 5 grams at a frequency of 2-3 times per week so as to inhibit sensitization to tree nuts. As stated before, tree nuts include almond, walnut, hazelnut, cashew, pistachio, pine nuts, Brazil nuts, macadamia nuts. The tree nut product of the invention is advantageous since a nut powder or blend is formed which is a combination of multiple highly allergenic nuts. This blend of nuts together can be used to inhibit IgE sensitization.

The tree nut product of the invention is also advantageous since a nut powder is formed with preferably even amounts by weight of the different nuts, and therefore the preparation has an even amount of nut protein. This is beneficial since “tree nut” allergies comprise 8 individual food allergies to the eight most common tree nuts, and it is desirable to inhibit sensitization to as many of the eight tree nuts as possible.

The invention is also advantageous since a nut powder preparation is formed which maintains the protein and nutrients of the raw nut ingredients. As a result, babies who consume the powder or blend will be exposed to the nut proteins, thereby inhibiting sensitization to a broad range of tree nuts. Babies who consume the powder will additionally consume fiber that is necessary to promote the growth of healthy gut bacteria.

The invention is advantageous in that the formed nut powder or blend has a significantly reduced fat and oil content which increases water solubility and water absorption characteristics. Enhanced water solubility allows the powder to blend into a wide range of baby-safe foods such as breastmilk and formula. More particularly, the inventive preparation has good water absorption and adhesion to water, with the ability to exhibit hydrogel-like (smooth) consistency when mixed with water.

Further, the inventive nut powder preparation is advantageous since adhesion of the individual granules to each other is minimized. This is because fat and oil are removed from the raw nut which, if present, help the particles to adhere to each other.

The inventive nut powder preparation is also advantageous as it can be safe to give to infants. This is because the reduced ability for nut particles to clump reduces the risk of a choking hazard.

The inventive nut powder preparation is also advantageous because every 5 g of powder will have 2 g of protein.

The scope of the invention will now be set forth in the following claims.

1. A method of producing an infant or baby food product comprising:
shelling a plurality of different tree nuts so that said plurality of different tree nuts are free from shell and skin;
crushing the plurality of shelled nuts in order to produce a nut paste;
defatting the nut paste by applying pressure to the nut paste without the introduction of water;
roasting or heating the nut paste without any hydration at a temperature of less than 90 degrees C.;
grinding or milling the defatted nut paste in order to produce a plurality of ground or milled nut particles of a size such that the ground or milled nut particles can pass through at least a 40 mesh screen; and
blending together the ground nut particles in order to produce a nut blend or powder having substantially the same amount of nut protein from each of said different tree nuts.

2. The method of claim 1, wherein the one or more nuts are selected from the group consisting of almonds, walnuts, pistachios and hazelnuts.

3. (canceled)

4. The method of claim 1, wherein roasting takes place for a time period of between 5 and 10 minutes.

5. (canceled)

6. The method of claim 1, wherein pressure is applied during the defatting step in an amount between about 1000 and 6000 psig for a time period of between about 5 and 20 minutes.

7. (canceled)

8. (canceled)

9. The method of claim 1, wherein the defatted nut paste is ground or milled so that the resulting powder is of a size such that it can pass through at least a 200 mesh screen.

10. The food product produced by the method of claim 1.

11. (canceled)

12. (canceled)

13. A method for reducing the risk of a food allergy to tree nuts, the method comprising preparing a food product in accordance with the steps of claim 1 and feeding said food product to a baby or infant of an age of at least four months old.

14. The method of claim 13, further including mixing the powdered food product into a food selected from the group consisting of breastmilk, formula and a pureed food prior to said feeding step.

15. The method of claim 14, wherein said feeding step is carried out in serving sizes of approximately 5 grams of the powdered food product and at a frequency of 2-3 times per week.

16. (canceled)

17. The method of claim 14, wherein said preparing step includes defatting the nut paste by applying pressure in an amount between about 1000 and 6000 psig for a time period of between about 5 and 20 minutes.
